(19) United States
(12) Patent Application Publication
(10) Pub. No.: US 2016/0321299 A1
(43) Pub. Date: Nov. 3, 2016

(54) METHOD AND SYSTEM FOR DETERMINING AND DISSEMINATING STANDARDIZED AGGREGATED MEASUREMENTS OF ACTIVITY

(71) Applicant: MasterCard International Incorporated, Purchase, NY (US)

(72) Inventor: Curtis VILLARS, Chatham, NJ (US)

(73) Assignee: MASTERCARD INTERNATIONAL INCORPORATED, Purchase, NY (US)

(21) Appl. No.: 14/699,395

(22) Filed: Apr. 29, 2015

(51) Int. Cl. G06F 17/30

(52) U.S. Cl. CPC G06F 17/30241; G06F 17/30321

(57) ABSTRACT

A method for generating indices of activity for geographic areas includes: receiving a plurality of activity values, each associated with an entity and geographic location; identifying a geographic grid, the grid including a plurality of geographic areas area of equal size and including zero or at least two geographic locations associated with an activity value; calculating a weight value for each geographic area, the weight value being based on at least (i) a first weight factor applied to each activity value in the respective geographic area and (ii) a second weight factor applied to each activity value associated with a geographic location in an adjacent geographic area; calculating an index value for each geographic area, the index value being based on the calculated weight value and an average weight value for each geographic area; and transmitting at least the calculated index value for one or more geographic areas.

### FIELD

The present disclosure relates to the generating of indices of activity for geographic areas, specifically the use of weighting values and a geographic grid to generate index values for activity in geographic areas across the geographic grid.

### BACKGROUND

The measurement of activity in a geographic area can be beneficial for any number of entities across any number of industries. For example, merchants may be highly interested in the activity of consumers conducting payment transactions to identify new marketing plans or location expansion. In another example, law enforcement may be interested in criminal activity in an area to develop new patrols and coverage to help combat crime. In yet another example, mobile network operators may be interested in cellular phone usage in an area to determine where to place additional towers to increase network coverage and strength.

However, the measuring of such activity can often be very difficult, if not impossible, to achieve, particularly when associating the measured activity with a specific geographic area. In many instances, such information may often be unavailable, or may be inaccessible for entities due to privacy concerns. By associating activity with a specific geographic location, the activity may be personally identifiable to a specific individual or business in instances where only that specific individual or business is located at the geographic location. For example, if criminal activity is being measured, and criminal activity is shown in a rural area where only a single individual lives, then that individual is singled out as being associated with the criminal activity, which may be undesirable for a measuring entity, a violation of privacy for the single individual (e.g., especially if that individual is a victim of a crime), and, in some instances, may even be against rules or regulations.

Thus, there is a need for a technical solution where activity can be measured for geographic areas without sacrificing individual privacy. Current systems lack the ability to handle sensitive data and to do so in a way that retains privacy of entities associated with the data, while also maintaining a high level of accuracy for measurement of activity. In addition, current systems lack methods for obscuring or otherwise modifying the data to maintain entity privacy while still adequately measuring activity. Further, existing systems also often measure activity with respect to geographic areas that are inconsistent in size and shape, such as based on municipality boundaries, which may result in inconsistencies in activity measurements, as well as provide less usefulness for the data. Accordingly, there is a need for a technical solution that can measure activity in a geographic area that uses indices and weight values to protect entity privacy while maintaining a high level of accuracy and data usability.

### SUMMARY

The present disclosure provides a description of systems and methods for generating indices of activity for geographic areas.

A method for generating indices of activity for geographic areas includes: receiving, by a receiving device, a plurality of activity values, wherein each activity value is associated with an entity and a geographic location; identifying, by a processing device, a geographic grid, wherein the geographic grid includes a plurality of geographic areas, each geographic area being of an equal size and including (i) no geographic locations associated with an activity value or (ii) two or more geographic locations associated with an activity value; calculating, by the processing device, a weight value for each geographic area in the identified geographic grid, wherein the weight value is based on at least (i) a first weight factor applied to each activity value associated with a geographic location included in the respective geographic area and (ii) a second weight factor applied to each activity value associated with a geographic location included in an adjacent geographic area; calculating, by the processing device, an index value for each geographic area in the identified geographic grid, wherein the index value is based on at least the calculated weight value for the respective geographic area and an average weight value for each geographic area in the identified geographic grid; and transmitting, by a transmitting device, at least the calculated index value for one or more geographic areas of the plurality of geographic areas included in the identified geographic grid.

A system for generating indices of activity for geographic areas includes a receiving device, a processing device, and a transmitting device. The receiving device is configured to receive a plurality of activity values, wherein each activity value is associated with an entity and a geographic location. The processing device is configured to: identify a geographic grid, wherein the geographic grid includes a plurality of geographic areas, each geographic area being of an equal size and including (i) no geographic locations associated with an activity value or (ii) two or more geographic locations associated with an activity value; calculate a weight value for each geographic area in the identified geographic grid, wherein the weight value is based on at least (i) a first weight factor applied to each activity value associated with a geographic location included in the respective geographic area and (ii) a second weight factor applied to each activity value associated with a geographic location included in an adjacent geographic area; and calculate an index value for each geographic area in the identified geographic grid, wherein the index value is based on at least the calculated weight value for the respective geographic area and an average weight value for each geographic area in the identified geographic grid. The transmitting device is configured to transmit at least the calculated index value for one or more geographic areas of the plurality of geographic areas included in the identified geographic grid.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for generating indices of activity for geographic areas in accordance with exemplary embodiments.

FIG. 2 is a block diagram illustrating the processing server of FIG. 1 for generating indices of activity for geographic areas in accordance with exemplary embodiments.

FIG. 3 is a flow diagram illustrating a process generating indices of activity for geographic areas using the processing server of FIG. 2 in accordance with exemplary embodiments.

FIGS. 4A-4C are diagrams illustrating the generating of indices of activity for geographic areas using weighting values in accordance with exemplary embodiments.

FIG. 5 is a flow chart illustrating an exemplary method for generating indices of activity for geographic areas in accordance with exemplary embodiments.

FIG. 6 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### System for Generating Indices of Activity for Geographic Areas

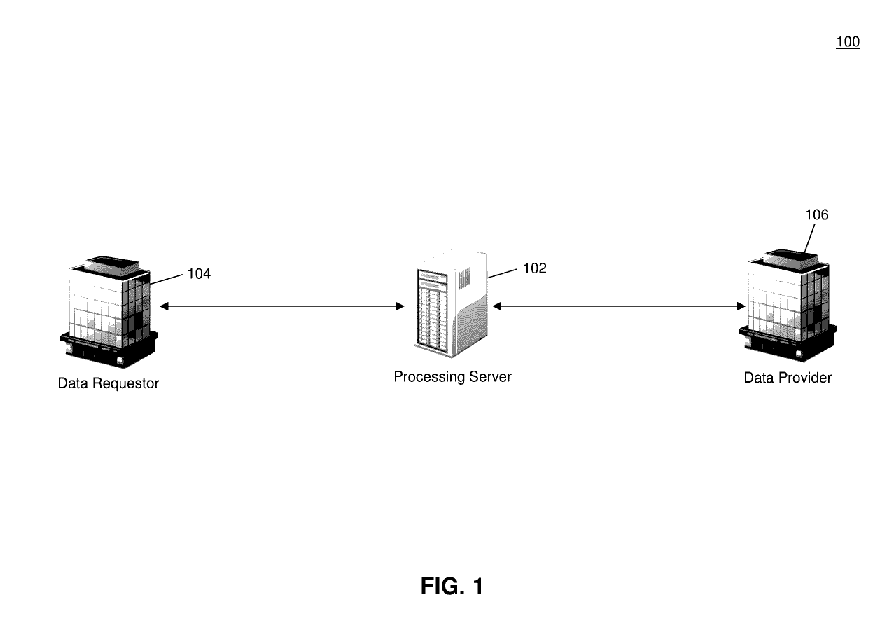

FIG. 1 illustrates a system 100 for the generating of indices of activity for geographic areas.

The system 100 may include a processing server 102. The processing server 102, discussed in more detail below, may be configured to generate indices of activity for geographic areas. The indices of activity may be generated by applying weighting values to a geographic grid used for association with measured activity. The indices of activity may be requested by a data requestor 104. The data requestor 104 may be an entity desiring the indices for a specific activity, and may be a third party entity, a user of a computing system comprised of or including the processing server 102, etc. For example, the data requestor 104 may be a merchant requesting activity regarding consumer transactions in a specific merchant industry.

The system 100 may also include a data provider 106. The data provider 106 may provide the processing server 102 with activity data for use in generating the indices of activity. The activity data typically includes a descriptor of the activity, preferably in a standardized form, and a geographic location assigned to the activity (e.g., the longitude and latitude of a point of sale used in a purchase of a specified product). The geographic location might be in the form of longitude and latitude, perhaps down to the minute or second, as determined by a device at the location via known GPS, cellular or WiFi or other geolocation determination techniques, or by a look-up data base of assigned locations (e.g., by the identification code of a point of sale (POS) terminal involved in a transaction that is transmitted with a transaction authorization request for example). Alternatively, other techniques can be used, such as assigned addresses, governmental boundaries and even zip-plus four postal codes, so long is there is not significant ambiguity in grid assignment due to overlapping boundaries between the grid and the geolocation determination mechanism chosen and the grid that is assigned to the geolocation for a given purpose. That is, if a grid would encompass a number of postal codes, only some of which extended outside the particular grid, using same might be sufficient for a given purpose. That said, using longitude and latitude for a geolocation can provide a technical advantage in that a simple comparison of the specific values to determine whether they are in the range of a specific grid would be computationally less intensive that determining the sometimes irregular boundary of a governmentally determined area. The data provider 106 may be a data collection agency, research firm, credit bureau, or any other suitable type of entity. In some embodiments, the data provider 106 may be the data requestor 104, such as in an instance where the data requestor 104 may want interpretation and analysis of data offered by the processing server 102. For example, a merchant requesting activity regarding consumer transactions in a specific merchant industry may collect available transaction data to provide to the processing server 102 for analysis and generation of indices. In some instances, the processing server 102 may request the activity data from a suitable data provider 106 after receiving a data request from the data requestor 104. For instance, in the above example, the processing server 102 may request transaction data from payment networks, transaction aggregators, or another suitable data provider 106 for consumer transactions in the specific merchant industry requested by the merchant data requestor 104.

The processing server 102, as discussed in more detail below, may identify a geographic grid for the measured activity. The geographic grid may include a plurality of geographic areas of equal size where each geographic area includes either no geographic locations associated with measured activity or at least two geographic locations associated with measured activity. By creating the grid such that each area includes at least two activity locations, or none, may ensure that no measurement of activity can be identifiable to a specific individual or entity, as the activity is split among at least two entities in that geographic area. For example, the level of granularity may be adjusted to ensure that each geographic area in the grid includes a sufficient number of geographic locations. For instance, a geographic grid for one area or activity may use areas of one square kilometer for example perhaps where population and/or activity is comparatively dense (e.g., New York City), while a geographic grid for another area or activity may use areas of ten square kilometers for example perhaps where population and/or activity is comparatively sparse (e.g., Montana). In some instances, a higher number of activity locations may be included in each geographic area, and may vary depending on the type of activity measured and the value of measurements. For example, the number of activity locations may be higher for criminal activity than for cellular phone usage.

In some instances, the area of each section of the geographic grid may be determined based on the geographic locations, such that each grid section includes either no geographic locations or at least a predetermined number of geographic locations associated with measured activity (e.g., five). In other instances, the area of each section may be predetermined (e.g., one square kilometer). In such an instance, if each section does not include either no geographic locations or the predetermined number of geographic locations, the methods and systems discussed herein may combine sections for use in performing the disclosed methods, such that the section that is used in the calculations and determinations discussed below includes at least the predetermined number of geographic locations. For example, if a section of the geographic grid includes only a single geographic location associated with the measured activity, the surrounding sections may also be included in the calculations discussed herein. If the section and surrounding sections combined still does not include the predetermined number of locations, the further surrounding sections may also be included, and so on, until a suitable level of privacy and security is obtained.

Once the grid has been identified, the processing server may calculate weight vales for each area in the grid. The weight values may be calculated based on application of a series of two or more weight factors to an activity value for each area in the geographic grid. The weight factors may be, as discussed in more detail below, values that are applied to the activity value in each area and/or activity values in surrounding geographic areas. For example, the activity value in a specific area may be adjusted by a first weight factor, then combined with the result of a second weight factor applied to activity values in surrounding areas, and may be further combined with the result of a third weight factor applied to activity values in areas surrounding the surrounding areas. The use of weight factors and the inclusion of activity values from surrounding areas may ensure that the activity values in a geographic area are obscured, to preserve security and privacy for associated entities, while maintaining a high level of accuracy.

In some embodiments, the value of the weight factors, the number of weight factors used, and the applicable geographic areas may all be identified based on the type of activity being measured, a level of privacy or security required (e.g., based on the activity, requested by the data requestor 104, set by the processing server 102, based on rules or regulations, etc.), the activity values, etc. In some instances, the processing server 102 may be configured to calculate or otherwise identify the weight factors used based on one or more criteria, the use of appropriate rules or algorithms, etc. For example, the processing server 102 may develop an algorithm for calculating weight factors based on a provided level of security and an average activity value. In some embodiments, the processing server 102 may repeat the calculation of weight values using weight factors until suitable weight values are identified. Suitable weight values may be weight values that satisfy requirements for privacy or security.

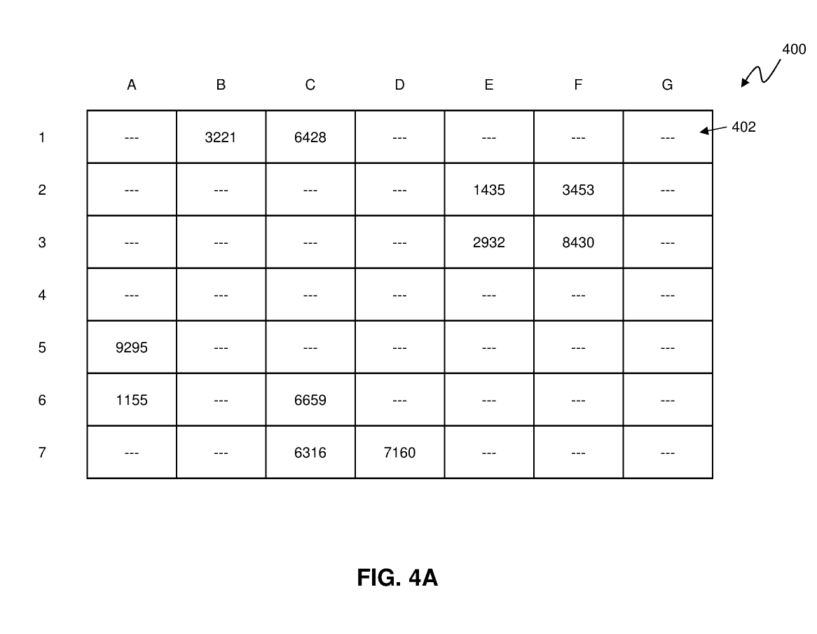

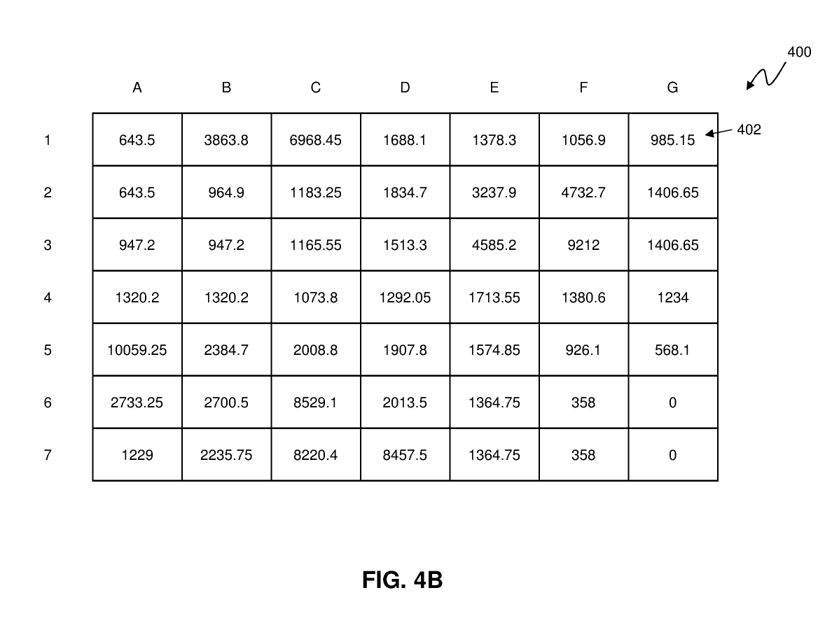

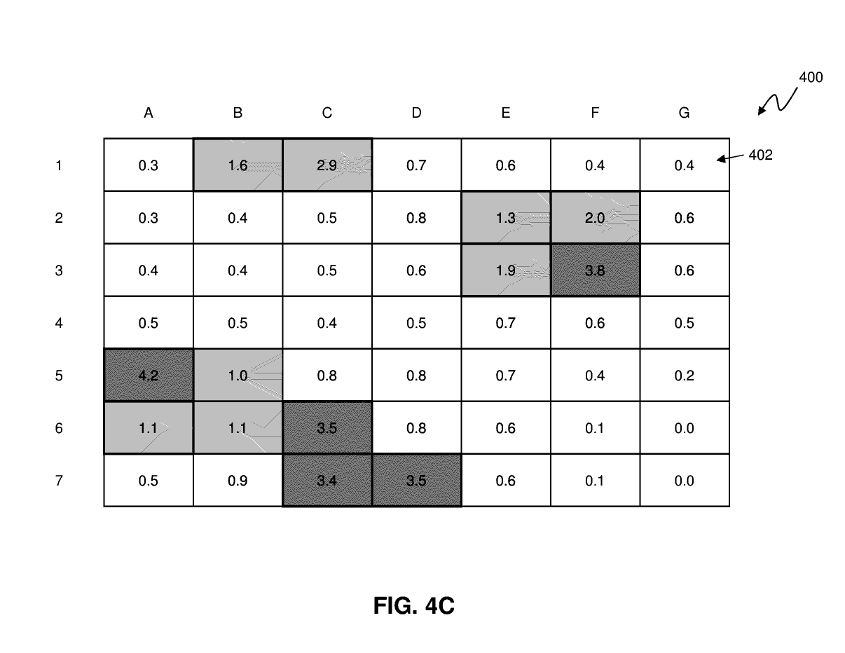

Once weight values are calculated, the processing server 102 may calculate an index value for each geographic area. The index value may be based on the weight value for the geographic area and an average weight value for all of the geographic areas in the geographic grid. The index value may then be associated with that geographic area and may be provided to the data requestor 104. In some embodiments, the processing server 102 may provide the data requestor 104 with a list of index values and associated geographic areas. In other embodiments, the processing server 102 may generate a representation of the geographic grid that includes the geographic areas and the associated index values, such as illustrated in FIG. 4C and discussed in more detail below. Additional types of representations of index values for geographic areas will be apparent to persons having skill in the relevant art.

The methods and systems discussed herein may enable the processing server 102 to generate indices of activity that are highly accurate representations of activity for a plurality of geographic areas, while maintaining a high level of security and privacy for individuals and entities associated with the activity data. The use of weight factors across multiple geographic areas and a specially identified geographic grid may ensure that no individual whose activity is considered is personally identifiable, which may enable the processing server 102 to generate indices for types of activity that are currently not measurable without an invasion of individual privacy. As a result, the methods and systems discussed herein can provide for more accurate representations of activity without sacrificing security or privacy via the use of specially identified geographic grids, weight factors, and weight values, which are unheard of in existing technical systems.

### Processing Server

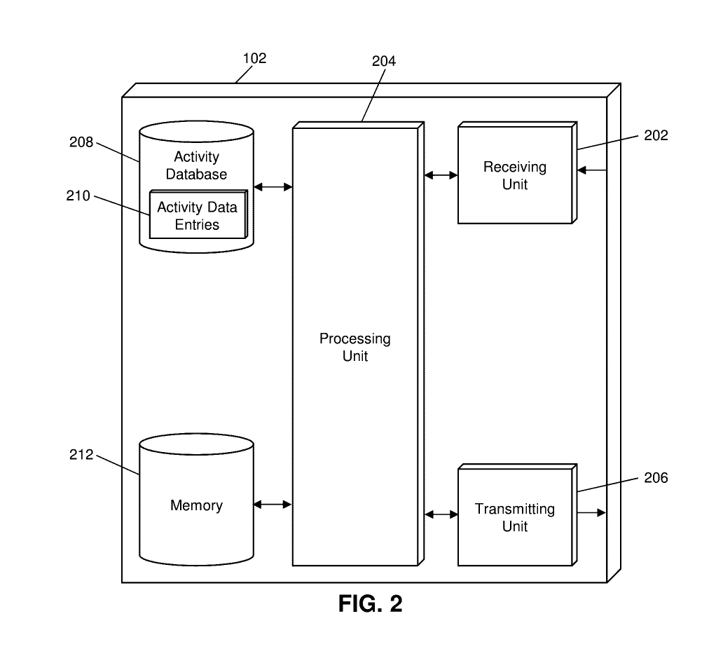

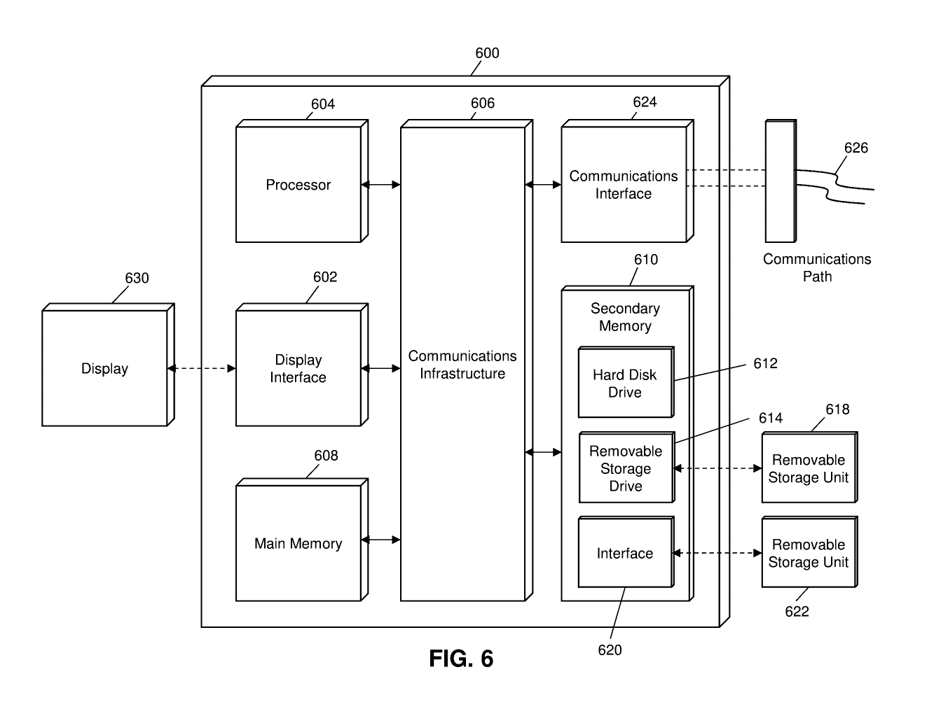

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 600 illustrated in FIG. 6 and discussed in more detail below may be a suitable configuration of the processing server 102.

The processing server 102 may include a receiving unit 202. The receiving unit 202 may be configured to receive data over one or more networks via one or more network protocols. The receiving unit 202 may receive activity data from data providers 106, and, in some instances, may be specially configured for the receipt of data. For instance, the receiving unit 202 may be configured to encrypt data upon receipt so that the processing server 102 does not possess any data potentially identifiable to an individual or entity. In another example, the receiving unit 202 may be specially configured to receive sensitive financial data over payment rails, such as may be transmitted using special protocols and data standards, that may be unavailable to traditional computing systems. The receiving unit 202 may also be configured to receive data requests from data requestors 104, which may be provided by third party entities and computing systems, or input into the processing server 102 via one or more input units.

The processing server 102 may also include a processing unit 204. The processing unit 204 may be configured to perform the functions of the processing server 102 discussed herein, as will be apparent to persons having skill in the relevant art. The processing unit 204 may be configured to identify geographic areas and/or geographic grids, identify weight factors, calculate weight values, calculate index values, generate representations of geographic grids and index values, and other functions discussed herein.

The processing server 102 may further include a transmitting unit 206. The transmitting unit 206 may be configured to transmit data over one or more networks via one or more network protocols. The transmitting unit 206 may transmit calculated index values and/or generated representations of the geographic grid. The transmitting unit 206 may also be configured to transmit data requests, such as to data providers 106 requesting activity data. Data requests may be generated by the processing unit 204 based on a received activity index request and data stored therein regarding the requested activity.

The processing server 102 may also include an activity database 208. The activity database 208 may be configured to store a plurality of activity data entries 210. Each activity data entry 210 may include data related to a measured activity including at least an activity value and an associated geographic location. In some embodiments, each activity data entry 210 may also include an activity identifier, which may identify the related activity. In other embodiments, each activity data entry 210 may include data related to a specific activity. In such an embodiment, the processing server 102 may include separate activity database 208 for separate activities, or may not retain activity data entries 210 for completed geographic grids. In some embodiments, the processing server 102 may not include an activity database 208 or the activity database 208 may be used for temporary storage only, such that any potentially sensitive data is not retained to protect individual and entity privacy and security.

The processing server 102 may further include a memory 212. The memory 212 may be configured to store data suitable for use by the processing server 102 in performing the functions discussed herein. For example, the memory 212 may include rules and algorithms for generating geographic grids, identifying weight factors, calculating weight values, calculating index values, generating grid representations, encrypting received data, receiving and transmitting data, etc. In some instances, the memory 212 may also be used to temporarily store received activity data. Additional data that may be stored in the memory 212 will be apparent to persons having skill in the relevant art.

### Process for Generating Indices of Activity

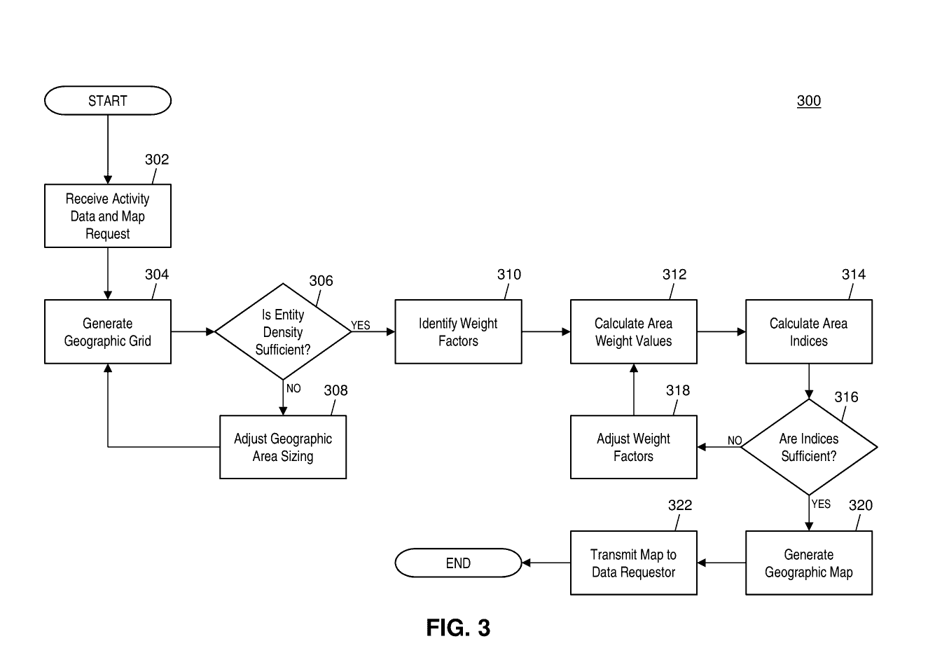

FIG. 3 illustrates a process 300 for generating indices of activity for geographic areas as performed by the processing server 102.

In step 302, the receiving unit 202 of the processing server 102 may receive activity data (e.g., from a data provider 106) and may receive a map request (e.g., from a data requestor 104). In some embodiments, step 302 may include receiving the map request and then transmitting (e.g., by the transmitting unit 206 of the processing server 102) an activity request to the data provider 106 prior to receipt of the activity data. The activity data may include at least a plurality of activity values, with each activity value being associated with a geographic location. The map request may include a request for indices for a specific type of activity and for an identified plurality of geographic areas. The map request may also indicate the type of representation requested for the calculated index values.

In step 304, the processing unit 204 of the processing server 102 may generate a geographic grid. The geographic grid may include a plurality of geographic areas encompassing the geographic locations associated with the received activity data and may each be of equal size and include either no activity locations or at least two activity locations. In step 306, the processing unit 204 may determine if the generated geographic grid has sufficient density of activity locations. Sufficient density may be determined by identifying if any entity associated with an activity value is identifiable in a geographic area as being directly associated with that activity value. If the density is not suitable, then, in step 308, the processing unit 204 may adjust the size of the geographic areas, such as by expanding them, to ensure proper density and entity privacy. For example, the processing unit 204 may increase the level of granularity, such as using the next highest order of measurement (e.g., from one square kilometer to ten square kilometers, from using coordinate degrees to coordinate minutes, etc.) In some instances, the processing unit 204 may combine geographic areas in order to ensure proper density, such as by combining a geographic area with its surrounding geographic areas.

Once a geographic grid has been identified where no entity is individually identifiable and privacy and security are maintained, then, in step 310, the processing unit 204 may identify two or more weight factors. The weight factors may be calculated using one or more rules or algorithms, such as stored in the memory 212 of the processing server 102, and may be based on activity values, geographic area densities, the type of activity measured, and other suitable criteria. In step 312, the processing unit 204 may calculate weight values for each geographic area in the geographic grid. The weight values may be calculated based on application of each of the weight factors to the appropriate geographic areas. In step 314, the processing unit 204 may calculate an index value for each geographic area based on the weight value calculated for that geographic area and an average weight value calculated for each geographic area in the geographic grid.

In step 316, the processing unit 204 may determine if the calculated index values are sufficient. The index values may be sufficient if the resulting values are such that an entity is not individually identifiable as a result of the index values. In some instances, sufficiency may also be based on the spread of index values, such that the values may be insufficient if every geographic area has values that are too close together. In some embodiments, sufficiency of index values may be based on criteria set forth by the data requestor 104, such as included in the received map request. If the index values are not sufficient, then, in step 318, the weight factors may be adjusted to obfuscate or otherwise change the resultant index values to protect entity privacy and security. For example, if the index values are too close together, the first weight factor applied to each geographic area may be increased and/or the second weight factor applied to surrounding geographic areas may be decreased.

Once the weight factors have been adjusted, the process may return to step 312, and new weight values and area indices calculated. Once, in step 316, the processing unit 204 determines that the weight factors have resulted in sufficient index values, then, in step 320, the processing unit 204 may generate a geographic map. The geographic map may be an illustration of the geographic grid and included geographic areas, including a representation of the associated index values. For instance, the geographic map may be a heat map that may show intensity based on the index values associated with each geographic area. Additional types of graphical representations will be apparent to persons having skill in the relevant art. It will also be apparent that, in some instances, an illustration may be optional, and instead a textual representation of the data may be generated, such as list of geographic areas and associated index values. In step 322, the transmitting unit 206 of the processing server 102 may transmit the generated map to the data requestor 104 in response to the received map request.

### Example Generation of Activity Index Values for Geographic Areas

FIGS. 4A-4C illustrate weight values and activity indices generated in an example implementation of the methods and systems discussed herein, such as using the process 300 illustrated in FIG. 3 and discussed above.

FIG. 4A illustrates a table 400. The table 400 is a geographic grid, such as identified by the processing unit 204 of the processing server 102 for received activity data, and includes a plurality of geographic areas 402. Each geographic area 402 includes either activity values for no measured activity, such as areas A1, C2, and D6, or includes activity values for two or more entities, such as areas A5, C1, and E3. As illustrated in FIG. 4A, some the activity value in geographic areas 402 may vary, depending on the amount of activity measured for the geographic locations included in the respective geographic area 402. For example, if FIG. 4A illustrates the number of consumer transactions at merchants in a merchant industry, the table 400 indicates that there have been 3,221 transactions at merchants in the geographic area represented by area B1, and 8,430 transactions at merchants in the geographic area represented by F3.

FIG. 4B illustrates the table 400 once weight values for each geographic area 402 have been calculated using the application of three weight factors to each geographic area 402. In the illustrated example, a weight factor of 1 has been applied to each geographic area 402, a weight factor of 0.1 has been applied to each surrounding geographic area, and a weight factor of 0.05 has been applied to each geographic area surrounding the surrounding geographic areas, with each of the results summed together to arrive at the weight value indicated in the table 400 illustrated in FIG. 4B.

FIG. 4C illustrates the table 400 once index values have been calculated for each geographic area 402 based on the calculated weight values. In the illustrated example, each index value has been calculated based on dividing the weight value for the geographic area 402 with an average weight value calculated for all geographic areas 402 in the geographic grid. As also illustrated in FIG. 4C, the geographic areas 402 have been shaded based on the respective index value, such as in a heat map, with a higher index value resulting in a darker shade of gray for the respective geographic area 402. In the example where the values are representative of consumer transactions conducted in the associated area, the shades may indicate intensity of transaction activity for the respective geographic areas 402.

In FIG. 4C, geographic areas 402 that included measured activity, such as areas A5, C1, and E3, have a thicker border. The table 402 thus illustrates that the geographic areas 402 where activity was measured have been obscured, due to geographic areas 402 where no activity occurred, such as area B6, having an index value that may be indicative to a reviewer of there having been activity measured in the area. It will be apparent to persons having skill in the art that in some embodiments, the geographic areas 402 where activity was measured may not be indicated in the data and/or representation provided to the data requestor 104.

As illustrated in FIG. 4C, the methods and systems discussed herein may lead to the calculation of index values that are highly representative of measured activity, while still protecting entity privacy and security. For instance, in the illustrated example, the intensity of the index values illustrates that a large number of transactions are conducted in the southwestern part of the geographic grid without indicating if any particular geographic area 402 includes a measured entity, particularly with respect to the similarity in index values for areas A6, B5, and B6.

### Exemplary Method for Generating Indices of Activity for Geographic Areas

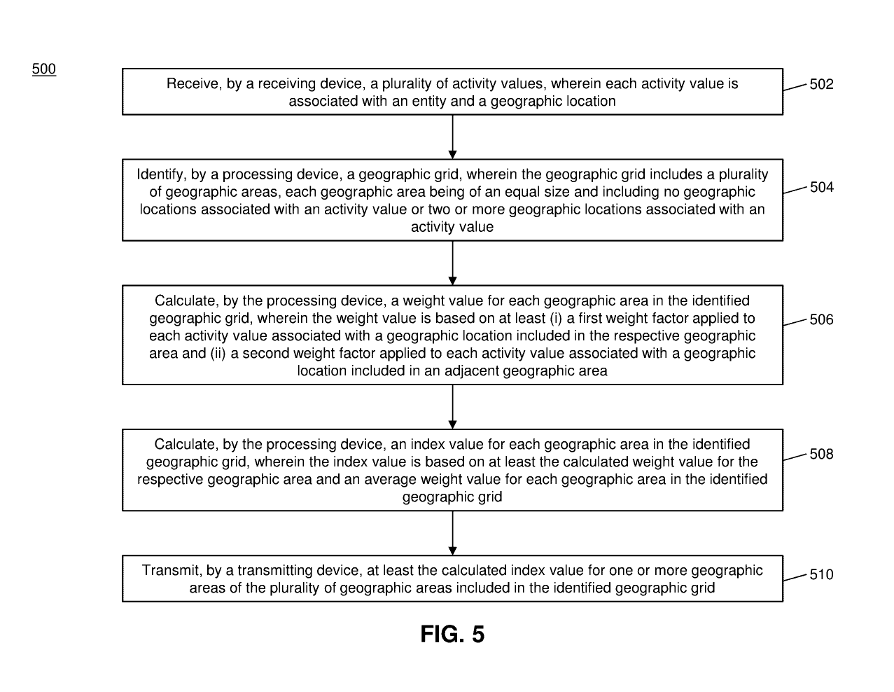

FIG. 5 illustrates a method 500 for generating indices of activity for geographic areas using weight factors and calculated weight values on a geographic grid.

In step 502, a plurality of activity values may be received by a receiving device (e.g., the receiving unit 202), wherein each activity value is associated with an entity and a geographic location. In step 504, a geographic grid may be identified by a processing device (e.g., the processing unit 204), wherein the geographic grid includes a plurality of geographic areas, each geographic area being of an equal size and including no geographic locations associated with an activity value or two or more geographic locations associated with an activity value. In one embodiment, each geographic area in the geographic grid may be a square.

In step 506, a weight value may be calculated by the processing device 204, wherein the weight value is based on at least (i) a first weight factor applied to each activity value associated with a geographic location included in the respective geographic area and (ii) a second weight factor applied to each activity value associated with a geographic location included in an adjacent geographic area. In one embodiment, the weight value may be further based on a third weight factor applied to each activity value associated with a geographic location included in a tertiary geographic area adjacent to an adjacent geographic area.

In step 508, an index value may be calculated by the processing device 204 for each geographic area in the identified geographic grid, wherein the index value is based on at least the calculated weight value for the respective geographic area and an average weight value for each geographic area in the identified geographic grid. In step 510, at least the calculated index value for one or more geographic areas of the plurality of geographic areas included in the identified geographic grid may be transmitted by a transmitting device (e.g., the transmitting unit 206).

In one embodiment, the method 500 may also include storing, in a memory (e.g., the memory 212), the first weight factor and the second weight factor. In some embodiments, the method 500 may further include storing, in the memory 212, one or more rules and algorithms, and identifying, by the processing device 204, the first weight factor and the second weight factor based on the one or more stored rules or algorithms. In a further embodiment, the first weight factor and the second weight factor may be further based on a density of geographic locations associated with activity values included in each geographic area included in the geographic grid.

In one embodiment, the method 500 may also include receiving, by the receiving device 202, the first weight factor and the second weight factor. In some embodiments, the method 500 may further include generating, by the processing device 204, a map, wherein the map illustrates each geographic area included in the geographic grid and indicates the respective calculated index value. In a further embodiment, the calculated index value may be indicated via shading of the respective geographic area and wherein an intensity or color of the shading is based on the calculated index value. In another further embodiment, transmitting the calculated index value may include transmitting the generated map.

### Computer System Architecture

FIG. 6 illustrates a computer system 600 in which embodiments of the present disclosure, or portions thereof, may be implemented as computer-readable code. For example, the processing server 102 of FIG. 1 may be implemented in the computer system 600 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3 and 5.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 618, a removable storage unit 622, and a hard disk installed in hard disk drive 612.

Various embodiments of the present disclosure are described in terms of this example computer system 600. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. The processor device 604 may be connected to a communications infrastructure 606, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 600 may also include a main memory 608 (e.g., random access memory, read-only memory, etc.), and may also include a secondary memory 610. The secondary memory 610 may include the hard disk drive 612 and a removable storage drive 614, such as a floppy disk drive, a magnetic tape drive, an optical disk drive, a flash memory, etc.

The removable storage drive 614 may read from and/or write to the removable storage unit 618 in a well-known manner. The removable storage unit 618 may include a removable storage media that may be read by and written to by the removable storage drive 614. For example, if the removable storage drive 614 is a floppy disk drive or universal serial bus port, the removable storage unit 618 may be a floppy disk or portable flash drive, respectively. In one embodiment, the removable storage unit 618 may be non-transitory computer readable recording media.

In some embodiments, the secondary memory 610 may include alternative means for allowing computer programs or other instructions to be loaded into the computer system 600, for example, the removable storage unit 622 and an interface 620. Examples of such means may include a program cartridge and cartridge interface (e.g., as found in video game systems), a removable memory chip (e.g., EEPROM, PROM, etc.) and associated socket, and other removable storage units 622 and interfaces 620 as will be apparent to persons having skill in the relevant art.

Data stored in the computer system 600 (e.g., in the main memory 608 and/or the secondary memory 610) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 600 may also include a communications interface 624. The communications interface 624 may be configured to allow software and data to be transferred between the computer system 600 and external devices. Exemplary communications interfaces 624 may include a modem, a network interface (e.g., an Ethernet card), a communications port, a PCMCIA slot and card, etc. Software and data transferred via the communications interface 624 may be in the form of signals, which may be electronic, electromagnetic, optical, or other signals as will be apparent to persons having skill in the relevant art. The signals may travel via a communications path 626, which may be configured to carry the signals and may be implemented using wire, cable, fiber optics, a phone line, a cellular phone link, a radio frequency link, etc.

The computer system 600 may further include a display interface 602. The display interface 602 may be configured to allow data to be transferred between the computer system 600 and external display 630. Exemplary display interfaces 602 may include high-definition multimedia interface (HDMI), digital visual interface (DVI), video graphics array (VGA), etc. The display 630 may be any suitable type of display for displaying data transmitted via the display interface 602 of the computer system 600, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 608 and secondary memory 610, which may be memory semiconductors (e.g., DRAMs, etc.). These computer program products may be means for providing software to the computer system 600. Computer programs (e.g., computer control logic) may be stored in the main memory 608 and/or the secondary memory 610. Computer programs may also be received via the communications interface 624. Such computer programs, when executed, may enable computer system 600 to implement the present methods as discussed herein. In particular, the computer programs, when executed, may enable processor device 604 to implement the methods illustrated by FIGS. 3 and 5, as discussed herein. Accordingly, such computer programs may represent controllers of the computer system 600. Where the present disclosure is implemented using software, the software may be stored in a computer program product and loaded into the computer system 600 using the removable storage drive 614, interface 620, and hard disk drive 612, or communications interface 624.

Techniques consistent with the present disclosure provide, among other features, systems and methods for generating indices of activity for geographic areas. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for generating indices of activity for geographic areas, comprising:
receiving, by a receiving device, a plurality of activity values, wherein each activity value is associated with an entity and a geographic location;
identifying, by a processing device, a geographic grid, wherein the geographic grid includes a plurality of geographic areas, each geographic area being of an equal size and including (i) no geographic locations associated with an activity value or (ii) two or more geographic locations associated with an activity value;
calculating, by the processing device, a weight value for each geographic area in the identified geographic grid, wherein the weight value is based on at least (i) a first weight factor applied to each activity value associated with a geographic location included in the respective geographic area and (ii) a second weight factor applied to each activity value associated with a geographic location included in an adjacent geographic area;
calculating, by the processing device, an index value for each geographic area in the identified geographic grid, wherein the index value is based on at least the calculated weight value for the respective geographic area and an average weight value for each geographic area in the identified geographic grid; and
transmitting, by a transmitting device, at least the calculated index value for one or more geographic areas of the plurality of geographic areas included in the identified geographic grid.

2. The method of claim 1, further comprising:
storing, in a memory, the first weight factor and the second weight factor.

3. The method of claim 1, further comprising:
storing, in a memory, one or more rules or algorithms; and
identifying, by the processing device, the first weight factor and the second weight factor based on the stored one or more rules or algorithms.

4. The method of claim 3, wherein the first weight factor and the second weight factor are further based on a density of geographic locations associated with activity values included in each geographic area included in the geographic grid.

5. The method of claim 1, further comprising:
receiving, by the receiving device, the first weight factor and the second weight factor.

6. The method of claim 1, wherein the weight value calculated for each geographic area in the identified geographic grid is further based on a third weight factor applied to each activity value associated with a geographic location included in a tertiary geographic area adjacent to an adjacent geographic area.

7. The method of claim 1, wherein each geographic area included in the geographic grid is a square.

8. The method of claim 1, further comprising:
generating, by the processing device, a map, wherein the map illustrates each geographic area included in the geographic grid and indicates the respective calculated index value.

9. The method of claim 8, wherein the calculated index value is indicated via shading of the respective geographic area and wherein an intensity or color of the shading is based on the calculated index value.

10. The method of claim 8, wherein transmitting the calculated index value for one or more geographic areas of the plurality of geographic areas included in the identified geographic grid includes transmitting the generated map.

11. A system for generating indices of activity for geographic areas, comprising:
a receiving device configured to receive a plurality of activity values, wherein each activity value is associated with an entity and a geographic location;
a processing device configured to
identify a geographic grid, wherein the geographic grid includes a plurality of geographic areas, each geographic area being of an equal size and including (i) no geographic locations associated with an activity value or (ii) two or more geographic locations associated with an activity value,
calculate a weight value for each geographic area in the identified geographic grid, wherein the weight value is based on at least (i) a first weight factor applied to each activity value associated with a geographic location included in the respective geographic area and (ii) a second weight factor applied to each activity value associated with a geographic location included in an adjacent geographic area, and
calculate an index value for each geographic area in the identified geographic grid, wherein the index value is based on at least the calculated weight value for the respective geographic area and an average weight value for each geographic area in the identified geographic grid, and
a transmitting device configured to transmit at least the calculated index value for one or more geographic areas of the plurality of geographic areas included in the identified geographic grid.

12. The system of claim 11, further comprising:
a memory configured to store the first weight factor and the second weight factor.

13. The system of claim 11, further comprising:
a memory configured to store one or more rules or algorithms, wherein
the processing device is further configured to identify the first weight factor and the second weight factor based on the stored one or more rules or algorithms.

14. The system of claim 13, wherein the first weight factor and the second weight factor are further based on a density of geographic locations associated with activity values included in each geographic area included in the geographic grid.

15. The system of claim 11, wherein the receiving device is further configured to receive the first weight factor and the second weight factor.

16. The system of claim 11, wherein the weight value calculated for each geographic area in the identified geographic grid is further based on a third weight factor applied to each activity value associated with a geographic location included in a tertiary geographic area adjacent to an adjacent geographic area.

17. The system of claim 11, wherein each geographic area included in the geographic grid is a square.

18. The system of claim 11, wherein the processing device is further configured to generate a map, wherein the map illustrates each geographic area included in the geographic grid and indicates the respective calculated index value.

19. The system of claim 18, wherein the calculated index value is indicated via shading of the respective geographic area and wherein an intensity or color of the shading is based on the calculated index value.

20. The system of claim 18, wherein transmitting the calculated index value for one or more geographic areas of the plurality of geographic areas included in the identified geographic grid includes transmitting the generated map.
